(19) United States
(12) Patent Application Publication
(10) Pub. No.: US 2009/0009861 A1
(43) Pub. Date: Jan. 8, 2009

(54) Optical Sheet, Image Display Device, and Screen for Image Projector

(75) Inventor: Yukihiro Hyobu, Tokyo (JP)

Correspondence Address: BACON & THOMAS, PLLC, 625 SLATERS LANE, FOURTH FLOOR, ALEXANDRIA, VA, 22314-1176, US

(73) Assignee: MIRAIAL CO., LTD, Tokyo (JP)

(21) Appl. No.: 12/223,666

(22) PCT Filed: Feb. 13, 2007
(86) PCT No.: PCT/JP2007/052526

§ 371 Date: Aug. 6, 2008

(30) Foreign Application Priority Data
Feb. 10, 2006 (JP) 2006-034298
Mar. 10, 2006 (JP) 2006-066635

(51) Int. Cl. G03B 21/62; G02B 27/12; G03B 21/56

(52) U.S. Cl. 359/456; 359/619; 359/443

(57) ABSTRACT

An optical sheet of the present invention is constituted by a micro-lens array sheet formed with a flat face and a back face having micro lenses aligned laterally and longitudinally and an anisotropic light-absorbing sheet with different light absorbing properties depending on incident angle of incident light entering an incident face arranged oppositely and proximally to each other. The optical sheet may be constituted by the micro-lens array sheet, the anisotropic light-absorbing sheet, a pinhole array sheet and a light diffusing sheet arranged proximally in this order. In an image display device of the present invention, the optical sheet of the present invention is arranged proximally to a display face of an image display element. The anisotropic light-absorbing sheet of the present invention has through cavities surrounded by light-absorbing side walls mutually sharing the side walls and collected closely in a large number.

### TECHNICAL FIELD

The present invention relates to an optical sheet, an image display device, and a screen for image projector.

### BACKGROUND ART

The image display device needs favorable visibility to a plurality of observers located at different positions, while external light such as a light ray from a light source in a room where the image display device is installed and a light ray entering the room through a window and the like is required not to deteriorate a quality of a displayed image.

In order to satisfy some of these several requests, arrangement of an optical sheet on a visible side (front face side) of the image display device is also proposed.

The paragraph [0003] in Patent Document 1, for example, describes provision of an anti-glare polarizer on the visible side of the image display device with the purpose of anti-glare.

Also, Patent Document 2 describes bonding of an optical sheet on which a large number of needle-like light guide bodies are arranged onto the front face of a display panel in view of improvement of contrast and restraint of infection of the external light, for example. Also, it describes that a micro lens may be arranged at a top end portion of the needle-like light guide body.

Also, image projectors such as a projector using CRT, liquid crystal projector, projector using micro-mirror device and the like have been further prevailing. A screen used for such image projector needs favorable visibility to a plurality of observers located at different positions, while external light such as a light ray from a light source in a room where the image projector is installed and a light ray entering the room through a window and the like is required not to deteriorate a quality of a displayed image on the screen.

Patent Document 3 describes a screen having a louver-shaped light-absorbing wall row for restraining image quality deterioration caused by external light, for example. The louver-shaped light-absorbing wall row extends in the horizontal direction and is provided while entering in the thickness direction from the face of a transparent member. An incident angle of the external light reflected on the face of the transparent member advances in a direction irrelevant to a visual field of the observer by its reflection.

The external light having advanced into the inside from the face of the transparent member is absorbed by the louver-shaped light-absorbing wall row and does not reach the observer.

In order to ensure favorable visibility and to restrain image quality deterioration caused by external light, Patent Document 4 uses a sheet in which a columnar region with high refractive index and a columnar region with low refractive index are present in a mixed state. Use of a through hole as the columnar region with low refractive index is also described. The above requirement is satisfied by passing through or reflection at a boundary between the columnar region with high refractive index and the columnar region with low refractive index depending on an incident direction.

### Patent Document 1: Japanese Patent Laid-Open No. 2000-162441

### Patent Document 2: Japanese Patent Laid-Open No. 2005-221906

### Patent Document 3: Japanese Patent Laid-Open No. 11-167167

### Patent Document 4: Japanese Patent Laid-Open No. 2005-326824

### DISCLOSURE OF THE INVENTION

### Problem to be Solved by the Invention

However, in the case of the art described in Patent Document 1, there is a problem that a light power from an image display element is considerably reduced through an anti-glare polarizer.

In the case of the art described in Patent Document 2, since the optical sheet has a large number of needle-like light guide bodies arranged, there is a problem that manufacture and handling are difficult. That is, since the light guide body is in a needle state, there is a problem that the light guide body is easily broken by contact. Also, since a micro lens is formed at the top end portion in an extremely small area of the needle-like light guide body, formation can easily fail, which might reduce yield rate of the optical sheet.

Thus, an easy-to-manufacture and low-cost image display device which can improve contrast and restrain infection of external light and an optical sheet applied to that are in demand.

Also, with the screen using the louver-shaped light-absorbing wall row, the light-absorbing wall row should be provided inside the transparent member, which leads to a problem of complicated manufacture and high costs. Also, since the light-absorbing wall row should be provided within the transparent member, a large-sized device can not be manufactured easily. Moreover, though infection of external light from above or below can be restrained, infection of external light from the right-and-left direction can not be restrained.

Moreover, with the screen using the sheet in which the columnar region with high refractive index and the columnar region with low refractive index are present in a mixed state, a large number of the columnar region with high refractive index and the columnar region with low refractive index should be formed on the sheet, which leads to a problem of complicated manufacture and high costs. Moreover, since the infection of external light is restrained by polarization in this system, there is a fear that a part of the external light might advance toward an observer and restraint on the infection of external light is insufficient depending on the intensity of the external light.

Therefore, a screen for image projector that can restrain infection of external light by absorption and for which cost reduction can be expected is in demand. Also, a sheet-like optical component having different absorbing characteristics depending on the incident direction, which can be manufactured easily and for which cost reduction can be expected is in demand. Also, a manufacturing method that can manufacture such sheet-like optical component easily and with low costs is in demand.

### Means to Solve the Problems

An optical sheet of a first aspect of invention comprising: a micro-lens array sheet with a flat face, and a back face having micro lenses aligned laterally and longitudinally; and an anisotropic light-absorbing sheet with different light absorbing properties depending on an incident angle of incident light entering an incident face, the micro-lens array sheet and the anisotropic light-absorbing sheet being arranged oppositely and proximally to each other.

An optical sheet of a second aspect of invention wherein the micro-lens array sheet, the anisotropic light-absorbing sheet, and moreover, a pinhole array sheet are arranged proximally in this order.

An optical sheet of a third aspect of invention wherein the micro-lens array sheet, the anisotropic light-absorbing sheet, the pinhole array sheet, and moreover, a light-diffusing sheet are arranged proximally in this order.

An image display device of a fourth aspect of invention wherein in an image display device using an image display element for image display by modulating light intensity coming from each pixel depending on an electric signal, an optical sheet in which a micro-lens array sheet formed with a flat face and a back face having micro lenses aligned laterally and longitudinally and an anisotropic light-absorbing sheet with different light absorbing properties depending on an incident angle of incident light entering an incident face are arranged oppositely and proximally to each other is disposed so that the flat face of the micro-lens array sheet in the optical sheet is faced with a display face of the image display element.

In the optical sheet, a transparent adhesive that can be bonded to another optical part as necessary may be formed on the face of the micro-lens array sheet side. The anisotropic light-absorbing sheet is provided with a through cavity mutually sharing side walls in a state collected closely and in a large number and surrounded by the light-absorbing side walls. The light-absorbing side wall may be made by metal, glass containing light-absorbing pigment or polymer material containing light-absorbing pigment or dye. The light-absorbing side wall may be also constituted by forming a light-absorbing layer on its face. Each of the through cavity has the same shape and can be manufactured easily by aligning the plurality of through cavities regularly. With regard to each of the through cavities, its profile on a cross section orthogonal to the optical axis direction is not uniform, and it is possible to eliminate moire by arranging the plurality of through cavities irregularly. In a screen for image projector applied to the front-projection type image projector, the through cavity surrounded by the light-absorbing side walls preferably has the anisotropic light-absorbing sheets mutually sharing the side walls in a state collected closely and in a large number, a light diffusing layer, and a light-reflecting layer in this order. The screen for image projector preferably has the anisotropic light-absorbing sheet and the micro-lens array sheet. The optical axes of the micro lens constituting the micro-lens array sheet and that of the through cavity are preferably the same. A part of the micro-lens array sheet preferably has a through hole communicating with the both faces in order to transmit acoustics to front and rear faces of the sheet. Also, the through hole preferably communicates with the through cavity depending on the same optical axis. A pinhole array sheet having a pinhole close to a focal position of each of the micro lenses is preferably provided between the anisotropic light-absorbing sheet and the micro-lens array sheet.

### EFFECT OF THE INVENTION

According to the present invention, an easy-to-manufacture and low-cost optical sheet and an image display device that can improve contrast and restrain infection of external light can be realized.

According to the optical sheet and the image display device of the present invention, it becomes possible to emit light with efficiency by focusing each micro lens of the micro-lens array sheet without having display light absorbed by the anisotropic light-absorbing sheet, and a screen with high brightness can be obtained.

Moreover, according to the optical sheet and the image display device of the present invention, since there is no infection of external light, a clear display image can be displayed even with low brightness and as a result, the image display element can be driven with low power consumption.

Also, according to the present invention, a low-cost screen for image projector that can restrain infection of external light by absorption can be provided. Also, an easy-to-manufacture and low-cost anisotropic light-absorbing sheet that can be applied to a screen for image projector and has different absorbing characteristics depending on incident direction can be provided. Moreover, according to the present invention, an anisotropic light-absorbing sheet can be manufactured easily and with low costs. Furthermore, according to the present invention, an anisotropic light-absorbing sheet can be manufactured easily and with low costs by injection or punching press.

### BRIEF DESCRIPTION OF THE DRAWINGS

FIG. 1 is a schematically enlarged sectional diagram in an image display device of a first embodiment.

FIG. 2 is an outline perspective view illustrating an anisotropic light-absorbing sheet of the first embodiment.

FIG. 3 is an outline perspective view of a variation embodiment in the anisotropic light-absorbing sheet of the first embodiment.

FIG. 4 is an outline sectional diagram for explaining a function in the anisotropic light-absorbing sheet of the first embodiment.

FIG. 5 is an outline sectional diagram illustrating an optical sheet of a second embodiment.

FIG. 6 is a schematically enlarged sectional view in an image display device of a third embodiment.

FIG. 7 is an outline sectional view illustrating a screen for image projector of a fourth embodiment.

FIG. 8 is an outline sectional view illustrating a rear-projection image projector using the screen for image projector of the fourth embodiment.

FIG. 9 is an outline perspective view illustrating the fourth embodiment.

FIG. 10 is an outline perspective view of a variation embodiment illustrating the fourth embodiment.

FIG. 11 is an outline sectional view illustrating the variation embodiment in the anisotropic light-absorbing sheet of the fourth embodiment.

FIG. 12 is an outline sectional view illustrating a screen for image projector of a fifth embodiment.

FIG. 13 is an outline plan view illustrating arrangement of through holes in a micro-lens array sheet of the fifth embodiment.

FIG. 14 is an outline sectional view illustrating a screen for image projector of a sixth embodiment.

FIG. 15 is an outline sectional view illustrating a variation embodiment in the screen for image projector of the sixth embodiment.

FIG. 16 is an outline sectional view illustrating a screen for image projector of a seventh embodiment.

FIG. 17 is an explanatory diagram relating to a manufacturing method of an anisotropic light-absorbing sheet of the embodiments.

FIG. 18 is an explanatory diagram relating to a manufacturing method of a die for anisotropic light-absorbing sheet of the embodiments.

### EXPLANATION OF THE REFERENCE NUMERALS

1: image display element, 10, 10A, 10B: optical sheets, 11: micro-lens array sheet, 12: anisotropic light-absorbing sheet, 13: pinhole array sheet, 14: light-diffusing sheet, 60: image projector, 61, 61A, 61B, 61C, 61D: screens, 63: projector body, 70, 70A, 70C: micro-lens array sheets, 71: anisotropic light-absorbing sheet, 72: pinhole array sheet, 72a: pinhole array layer, 73: transparent flat plate, 74: light diffusing layer, 75: light-reflecting layer, 80: side wall, 81: through cavity, 90: through hole, 100: pinhole array sheet body, 101: pinhole

### BEST MODE FOR CARRYING OUT THE INVENTION

### (A) First Embodiment

A first embodiment of an optical sheet and an image display device using the same according to the present invention will be described below referring to the attached drawings.

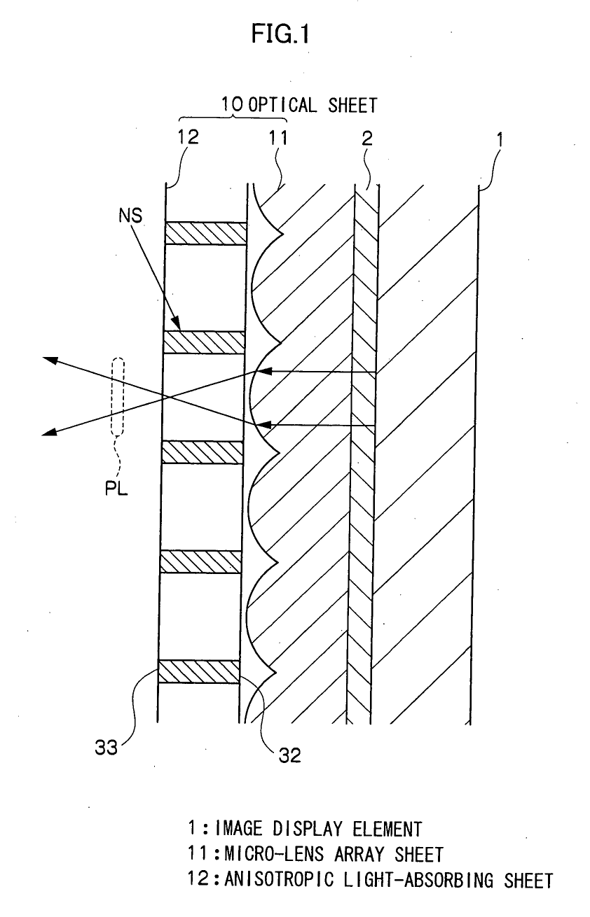

FIG. 1 is a schematically enlarged sectional diagram in the image display device of the first embodiment.

In FIG. 1, in the image display device of the first embodiment, an optical sheet 10 of the first embodiment is mounted on a display face of an image display element 1 by adhesion, for example (in FIG. 1, an adhesive layer is indicated by reference numeral 2).

The image display element 1 may be of any type and its display method or the like is not limited as long as an image is displayed by modulating light intensity when illumination light from a light source passes through each pixel or light intensity emitted from each pixel functioning as a light source based on an electric signal. In the image display device of the first embodiment, any type of image display device may be used as long as it is an image display device using the image display element 1 modulating and emitting light from itself depending on the electric signal, and liquid crystal display having a backlight, plasma display, field emission display, organic EL display, CRT display and the like can be applied, for example.

Thus, the optical sheet 10 of the first embodiment is affixed to a panel front face of the liquid crystal display, plasma display, field emission display, organic EL display and the like or affixed to a front face of a cathode ray tube of a CRT display.

The optical sheet 10 of the first embodiment comprises a micro-lens array sheet 11 and an anisotropic light-absorbing sheet 12 arranged from the display face side of the image display element 1 in the order.

Here, on the face of the anisotropic light-absorbing sheet 12, a protective film for preventing intrusion of dusts or mechanical damage is preferably bonded.

The micro-lens array sheet 11 has a large number of micro lenses aligned laterally and longitudinally, for example, as known, and an optical image incident to the micro-lens array sheet 11 is focused on each micro region by each micro lens. The micro-lens array sheet 11 has a micro lens face on one face and a flat face on the other face, in which the micro lens face is located on the side of anisotropic light-absorbing sheet 12 while an adhesive layer 2 is provided on the flat face.

Here, arrangement of the micro lenses in the micro-lens array sheet 11 may be matrix arrangement or delta arrangement. The arrangement of the micro lenses can be optimized in compliance with the pixel arrangement of the image display element 1.

In the optical sheet 10 of the first embodiment, a separator, not shown, is provided on the face of the adhesive layer 2 in a state before affixed to the image display element 1. At adhesion processing, the separator is removed and adhesion is made to the image display element 1. If the optical sheet 10 of the first embodiment does not have the adhesive layer 2 or the like but has only the micro-lens array sheet 11 and the anisotropic light-absorbing sheet 12 and is to be mounted on the display face of the image display element 1, adhesion or adhesion may be made by applying a transparent adhesive, adhesive and the like on the flat face of the micro-lens array sheet 11.

The anisotropic light-absorbing sheet 12 is provided separately from or in contact with the micro lens face side of the micro-lens array sheet 11. A method of integrating the micro-lens array sheet 11 and the anisotropic light-absorbing sheet 12 is not particularly limited. For example, they may be integrated by pressing the peripheries of the both sheets with a frame member or by adhesion or fusion at a peripheral frame portion.

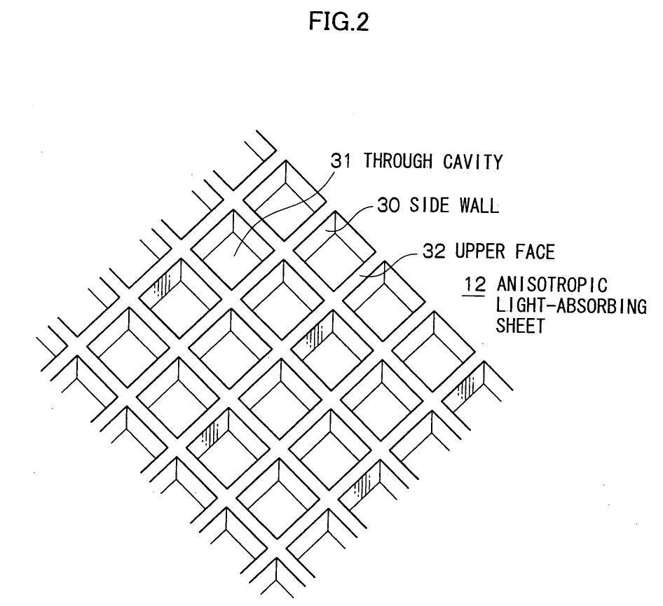

The anisotropic light-absorbing sheet 12 may be any type as long as a component in an incident direction within a predetermined range is made to pass with respect to display light incident from the micro-lens array sheet 11 while the component in the other incident direction is absorbed, and FIGS. 1 and 2 show configuration of an example of the anisotropic light-absorbing sheet 12. The anisotropic light-absorbing sheet 12 realizes an angle depending on a position of an allowed observer as a viewing angle of the optical sheet 10 and absorbs and removes external light from a light source in a room or from outside through a window.

In general, the light source in the room is a fluorescent light or incandescent light, while light ray entering the room through the window is solar light. The anisotropic light-absorbing sheet 12 is provided with absorption characteristics to visible light.

FIG. 2 is an outline perspective view illustrating configuration of the anisotropic light-absorbing sheet 12 used in the first embodiment. The anisotropic light-absorbing sheet 12 in the first embodiment is web-like in which through cavities 31 are surrounded by light-absorbing side walls 30 mutually sharing the side walls 30 and collected closely in a large number.

The through cavity 31 is a complete cavity and in other words, only air exists therein. A portion of the through cavity 31 may be filled with a translucent material such as translucent polymer material.

The light-absorbing side wall 30 may be fully formed by a single light-absorbing material or only the face of the side wall 30 may be formed by the light-absorbing material. A face (upper face) 32 on the micro-lens array sheet 11 side and a face (lower face) 33 on the opposite side preferably have the light absorbing property.

As the light absorbing material applied to the side wall 30, metal can be used, glass containing light-absorbing pigment can be used, polymer material containing the light-absorbing pigment or light-absorbing dye can be used, or light-absorbing ceramics can be used, for example.

By applying polymer material having flexibility such as polymer elastomer, polyethylene or vinyl chloride as the polymer material, the anisotropic light-absorbing sheet 12 and hence, the optical sheet 10 can be made flexible.

By applying a conductive polymer material and the like mixed with carbon particulates as the light-absorbing material of the side wall 30, adhesion of dusts on the face of the optical sheet 10 charged with static electricity can be prevented. Similarly, charging may be precluded by using an uncharged material other than the conductive polymer material mixed with carbon particulates or by non-charging processing. The non-charging processing is preferably applied similarly to the micro-lens array sheet 11.

When metal is used for the side wall 30, the light-absorbing side wall 30 may be formed by providing a light-absorbing layer on the face of the metal. Such light-absorbing layer may be formed by applying a light-absorbing paint or may be formed by covering with the light-absorbing pigment or light-absorbing dye. If aluminum is used as the metal, the light-absorbing layer may be provided by black anodized aluminum treatment. If chromium is applied as the metal, the light-absorbing layer may be provided by face treatment for controlling reflectivity on the face.

In an example shown in FIG. 2, each of the through cavities 31 has the same shape and they are arranged with regularity. Here, the through cavity 31 is illustrated with the sectional peripheral shape (hereinafter referred to as a profile) of a square on a face crossing the traveling direction of the light. As shown in FIG. 1, the optical sheet 10 in the first embodiment has an optical axis of each of the micro lenses in the micro-lens array sheet 11 matched with a center axis (axis obtained by extending the center of the square to the light traveling direction) of each through cavity 31 of the anisotropic light-absorbing sheet 12.

If the anisotropic light-absorbing sheet 12 is formed by regularly arranging the through cavities 31 with the same profile, it is easy to match the center axis with optical axis of each micro lens of the micro-lens array sheet 11 and to manufacture the anisotropic light-absorbing sheet 12.

Each micro lens in the micro-lens array sheet 11 may be in a size corresponding one by one to each pixel of the image display element 1 (in a color image display element, each pixel is constituted by R, G, B sub-pixels in general) or may be sufficiently smaller than each pixel area (preferably approximately ⅓ or less in area ratio or more preferably approximately 1/10 or less, for example). Even in the latter case, the lateral and longitudinal arrangements of the plurality of micro lenses are preferably made to correspond to a single pixel.

The anisotropic light-absorbing sheet 12 is not limited to those shown in FIGS. 1 and 2 but may be such that a large number of through cavities 31 are arranged irregularly. The profile of the through cavity 31 is not limited to a square, either, but a size (area) of the profile of each through cavity 31 does not have to be the same.

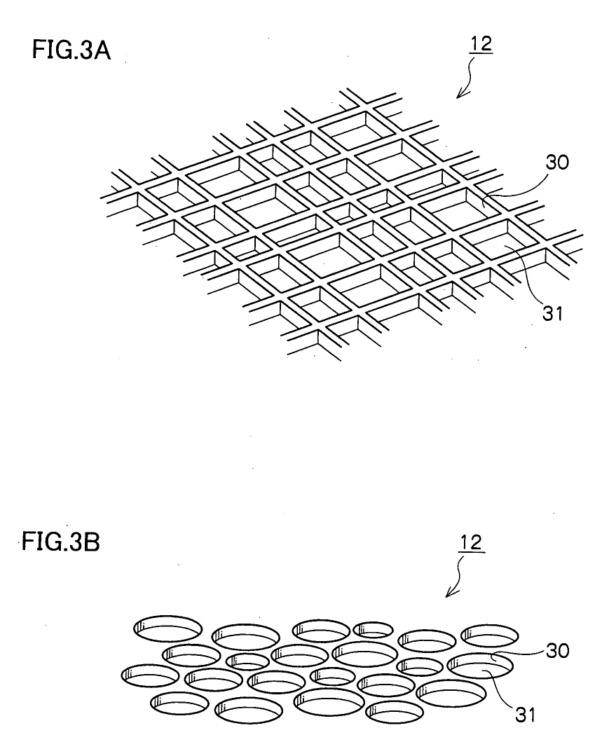

FIG. 3A shows the anisotropic light-absorbing sheet 12 in which the rectangular through cavities 31 with different profile sizes are arranged irregularly. FIG. 3B shows the anisotropic light-absorbing sheet 12 in which circular through cavities 31 with different profile sizes are arranged irregularly. Alternatively, a right triangle or a hexagon may be applied as a profile, for example. Here, even if the through cavities 31 are arranged irregularly, each micro lens of the micro-lens array sheet 11 is preferably made to correspond to each through cavity 31 one by one so that the optical axis of the micro lens matches the center axis of the through cavity 31.

Here, the anisotropic light-absorbing sheet 12 with the through cavities arranged irregularly has such a merit that the moire phenomenon can be restrained, though manufacture is more difficult than that of the anisotropic light-absorbing sheet with regular arrangement.

It is needless to say that plural types (two or three types, for example) of through cavities 31 with different profiles may be arranged regularly.

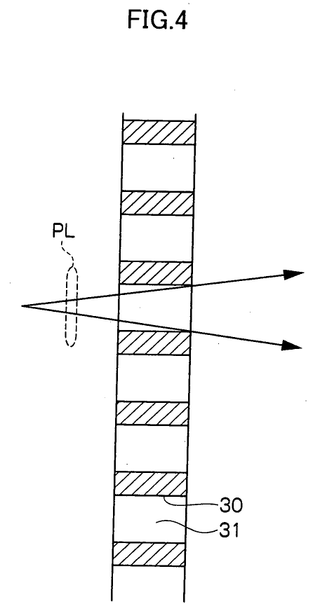

The anisotropic light-absorbing sheet 12 shown in FIGS. 1 and 2 has directivity of light to be transmitted limited by the light absorbing properties of the side wall 30 as shown in FIG. 4.

The light emitted from the image display face of the image display element 1 enters the optical sheet 10. On the image display element 1 side in the optical sheet 10, the micro-lens array sheet 11 is provided.

As shown in FIG. 1, parallel light PL incident to each micro lens is focused by each micro lens toward a predetermined point (point on focal plane) close to the outgoing side in the corresponding through cavity 31 of the anisotropic light-absorbing sheet 12, for example (the point on the focal plane may be at another position), and after having passed the predetermined point, the light becomes diverging light. The position of a focusing point (the point on the focal plane) may be selected considering a diverging angle so as to achieve a desired viewing angle and also considering that light absorption is not conducted by the side wall 30. Most of the diverging light does not collide with (incident to) the side wall 30 defining the through cavity 31 but passes through the through cavity 31 and is observed by an observer.

Among the focused light and diverging light, those colliding with (incident to) the side wall 30 defining the through cavity 31 are absorbed by the side wall 30. As mentioned above, a desired viewing angle as the optical sheet 10 is achieved.

Suppose that light ray emitted from an indoor light source such as a fluorescent light on a ceiling reaches the optical sheet 10 as external light (disturbance light) NS as shown in FIG. 1. In the case of the first embodiment, the anisotropic light-absorbing sheet 12 is provided on the face side of the optical sheet 10 exposed to the outside.

The external light NS incident with an angle to the anisotropic light-absorbing sheet 12 enters into the through cavity 31 and is absorbed by the side wall 30 having light absorbing properties and defining the through cavity 31 and removed. Even if several percents of the external light NS is reflected, the light is absorbed when it reaches the opposed side wall 30 and the more reflection is multiplied, the more completely the light is absorbed. Even if the incident angle is small, by selecting a longer length in the axial direction of the through cavity 31 (in other words, a thickness of the anisotropic light-absorbing sheet 12), the light reaches some spots of the side wall 30 and the external light NS is absorbed. Even if the light reaches the micro-lens array sheet 11 and is reflected on the front face of the sheet 11, when the light reaches some spots of the side wall 30 in a path after the reflection, the light is absorbed there.

As mentioned above, the profile of the through cavity 31 may be of any type, but an average diameter value of an inscribed circle or a circumscribed circle of the profile is preferably approximately 50 to 200 μm and a length in the axial direction of the through cavity 31 (thickness of the anisotropic light-absorbing sheet 12) is approximately 50 to 200 μm. A specific value may be selected from these ranges considering a viewing angle required for the optical sheet 10 and absorbing characteristic of the external light.

According to the optical sheet and the image display device of the first embodiment, by focusing with each micro lens of the micro-lens array sheet, efficient light emission without absorption of display light by the anisotropic light-absorbing sheet is enabled, and a screen with high brightness can be obtained. Also, by the light absorbing function of the anisotropic light-absorbing sheet, high contrast can be achieved.

Also, according to the optical sheet and the image display device of the first embodiment, since there is no infection of the external light, a clear display image can be displayed even at low brightness and as a result, the image display element can be driven with lower power consumption.

Moreover, according to the optical sheet of the first embodiment, since the through cavity surrounded by the light-absorbing side walls integrates the web-like anisotropic light-absorbing sheet mutually sharing the side walls and collected closely in a large number and the micro-lens array sheet together, manufacture is easy and low costs can be expected.

According to the image display device of the first embodiment, since the optical sheet of the first embodiment is additionally provided on the display face of the image display element, manufacture is easy and low costs can be expected.

### (B) Second Embodiment

Next, a second embodiment of the optical sheet according to the present invention and the image display device using the same will be described referring to the attached drawings.

An optical sheet 10A of the second embodiment is also mounted on the display face of the image display element similarly to the optical sheet 10 of the first embodiment by adhesion, for example (See FIG. 1).

The image display device of the second embodiment corresponds to such a device in which the optical sheet 10A of the second embodiment is provided on the display face of the image display element.

FIG. 5 is an outline sectional diagram illustrating the optical sheet 10A of the second embodiment. The optical sheet 10A of the second embodiment has the micro-lens array sheet 11, the anisotropic light-absorbing sheet 12, and a pinhole array sheet 13 arranged sequentially.

The micro-lens array sheet 11 and the anisotropic light-absorbing sheet 12 may be the same as those in the first embodiment. Also, as will be described later, the anisotropic light-absorbing sheet 12 may be integrated with the pinhole array sheet 13.

The pinhole array sheet 13 has a pinhole 51 provided at a light-absorbing pinhole array sheet body 50. The pinhole array sheet 13 may be formed as a single component or may be formed integrally with the output face of the anisotropic light-absorbing sheet 12. The pinhole 51 may be formed by applying a photo-etching method, for example.

Each pinhole 51 corresponds to the micro lens of the micro-lens array sheet 11 and the through cavity 31 of the anisotropic light-absorbing sheet 12, and their center axes match each other.

Each pinhole 51 is provided at a focal position or in the near field thereof of the corresponding micro lens. FIG. 5 shows a case where the through cavities 31 with the same shape are arranged regularly, but even if the through cavities 31 with varied sizes are arranged irregularly, each pinhole 51 is provided with the center axis of the corresponding through cavity 31 matched.

The pinhole 51 may be formed by a cavity (air layer) or may be a micro optical window with a transparent material present. Alternatively, the pinhole 51 may be applied treatment to give diffusivity to transmitted light. The pinhole 51 may be a cylindrical optical opening or an optical opening in a conical trapezoidal shape.

In the second embodiment, since the pinhole 51 is formed in the near field of a focusing point of the corresponding micro lens, the light focused by the micro lens is transmitted without being disturbed by the pinhole 51. The light having passed through the pinhole 51 is observed by an observer similarly to the first embodiment.

FIG. 5 shows an example where the pinhole is provided at an end portion of the anisotropic light-absorbing sheet 12, but it is needless to say that the pinhole may be provided at the center part (intermediate part when seen in the light traveling direction in the through cavity 31) of the anisotropic light-absorbing sheet 12, as long as the location is in the near field of the focus point by the micro lens. The same applies to a third embodiment, which will be described later.

The presence of the pinhole array sheet body 50 reduces a substantial opening and widens a black region on the screen, by which a high-contrast display screen can be provided to the observer.

The range of an incident angle of the external light transmitted through the pinhole array sheet 13 is narrowed, and the external light is absorbed and removed by the pinhole array sheet body 50. Even if the light should enter the anisotropic light-absorbing sheet 12 side through the pinhole 51, the light is absorbed and removed by the anisotropic light-absorbing sheet 12.

As mentioned above, according to the second embodiment, in addition to an effect similar to the first embodiment, an effect of improved image quality by provision of the pinhole array sheet can be expected. Particularly, improvement of contrast can be expected.

Since the contrast can be improved by the optical sheet 10A of the second embodiment, wide black matrix defining inter-pixel in the image display element can be omitted.

### (C) Third Embodiment

Next, the third embodiment of the optical sheet according to the present invention and the image display device using the same will be described referring to the attached drawings.

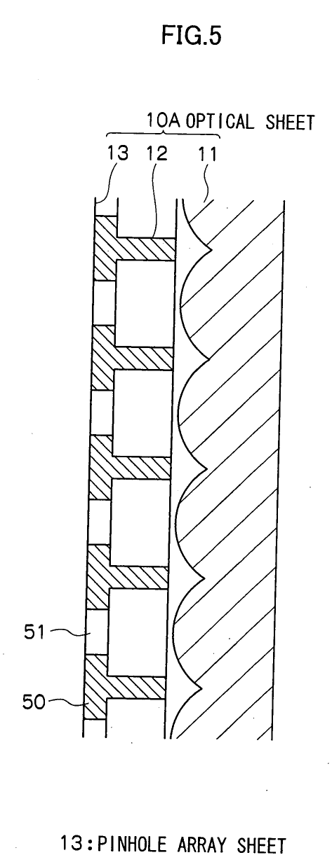

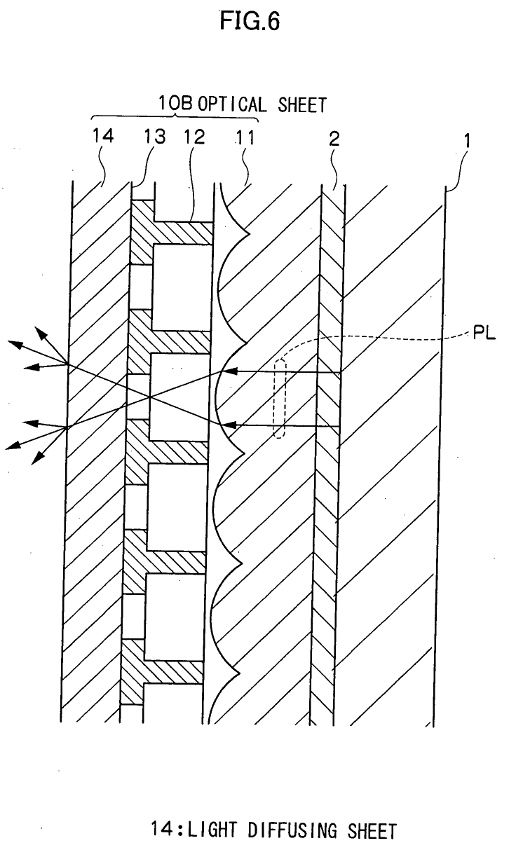

An optical sheet 10B of the third embodiment is also mounted similarly to the optical sheet 10 of the first embodiment or as shown in FIG. 6, on the display face of the image display element 1 by adhesion, for example. The image display device of the third embodiment corresponds to such a device in which the optical sheet 10B of the third embodiment is provided on the display face of the image display element 1.

In FIG. 6, in the optical sheet 10B of the third embodiment, the micro-lens array sheet 11, the anisotropic light-absorbing sheet 12, the pinhole array sheet 13, and the light-diffusing sheet 14 are arranged in this order.

The micro-lens array sheet 11, the anisotropic light-absorbing sheet 12, and the pinhole array sheet 13 are similar to those of the second embodiment.

The light-diffusing sheet 14 diffuses incident light by transmission through the light-diffusing sheet 14. The light-diffusing sheet 14 is mounted on the pinhole array sheet 13 by adhesion, fusion and the like. The light-diffusing sheet 14 may be formed as a diffusing layer on one face of the pinhole array sheet 13.

As the light-diffusing sheet 14, those having a large number of transparent beads made of acryl or styrene therein can be applied, for example. Also, as the light-diffusing sheet 14, those obtained by binding a scattering oxide (MgSO₄, MgO, BaSO₄ and the like) powder by polymer material can be applied, for example.

The parallel light PL incident to each micro lens is, as shown in FIG. 6, focused toward a predetermined point (point on a focal plane) close to the outgoing side in the corresponding through cavity 31 of the anisotropic light-absorbing sheet 12 by each micro lens, for example (the point on the focal plane may be another position), and after passing through the predetermined point, the light becomes the diverging light. The diverging light passes through the pinhole 51, enters the light-diffusing sheet 14 and is diffused and emitted to the outside. As a result, a desired viewing angle is achieved.

Even if the light ray emitted from an indoor light source such as a fluorescent light or incandescent light on a ceiling reaches the optical sheet 10B of the third embodiment as the external light (disturbance light), since the light ray is reflected and diffused, transmitted and diffused by the light-diffusing sheet 14, and a proportion irradiated to the pinhole array sheet body 50 can be better restrained than that of the second embodiment. Also, since the light-diffusing sheet 14 is provided on the face, reflection on the face can be restrained, and even if a protective film is not provided on the face of the anisotropic light-absorbing sheet 12 or the pinhole array sheet 13, internal intrusion of dusts through the pinhole 51 can be prevented.

In order to increase contrast using the light-diffusing sheet 14, it is preferable to apply non-reflection coating on the face of the light-diffusing sheet 14.

As mentioned above, according to the third embodiment, in addition to an effect similar to that of the second embodiment, an effect to improve image quality by provision of the light-diffusing sheet 14 and an effect to prevent internal intrusion of dusts can be expected.

### (D) Variation of the First to Third Embodiments

The image display device using the optical sheet of the present invention is not limited to those for color image but may be for monochrome image.

Also, an application of the image display device using the optical sheet of the present invention is not limited but can be applied to image display devices for all the applications. The device can be applied to a receiver set of a television signal, a display as a peripheral device of an information processor such as a personal computer, a display of a cellular phone and the like, for example.

A method of connecting various sheets to each other in each of the embodiments is naturally not limited to a method referred to in the explanation of the embodiments. A method of stapling the periphery can be also applied, for example.

Though not referred to in the explanation of each embodiment, the optical sheet preferably has a thickness of approximately 50 to 500 μm, considering ease of handling and light weight.

The first embodiment shows the optical sheet 10 having the micro-lens array sheet 11 and the anisotropic light-absorbing sheet 12, the second embodiment shows the optical sheet 10A having the micro-lens array sheet 11, the anisotropic light-absorbing sheet 12, and the pinhole array sheet 13, the third embodiment shows the optical sheet 10B having the micro-lens array sheet 11, the anisotropic light-absorbing sheet 12, the pinhole array sheet 13, and the light-diffusing sheet 14, but an optical sheet may be constituted by sequentially arranging the micro-lens array sheet, the anisotropic light-absorbing sheet, and the light-diffusing sheet.

### (E) Fourth Embodiment of Anisotropic Light-Absorbing Sheet and Screen for Image Projector

A fourth embodiment of an anisotropic light-absorbing sheet and a screen for image projector according to the present invention will be described referring to the attached drawings.

FIG. 8 is an outline sectional view illustrating a rear-projection image projector using the screen for image projector of the fourth embodiment. That is, the screen of the fourth embodiment is a so-called rear screen.

In FIG. 8, an image projector 60 has a dark box formed by a screen 61 of the fourth embodiment and an enclosure frame 62, and a projector body 63 and a mirror 64 are disposed in the dark box, for example. The projector body 63 comprises, though not shown in detailed configuration, an optical image forming portion using a CRT, liquid crystal panel or micro-mirror device and the like, a projector lens device for enlarging and projecting a formed optical image, a light source, and a driving circuit, and the optical image emitted from the projector body 63 is reflected by the mirror 64 and its traveling direction is directed toward the screen 61 side, and the image reaches an observer through the screen 61.

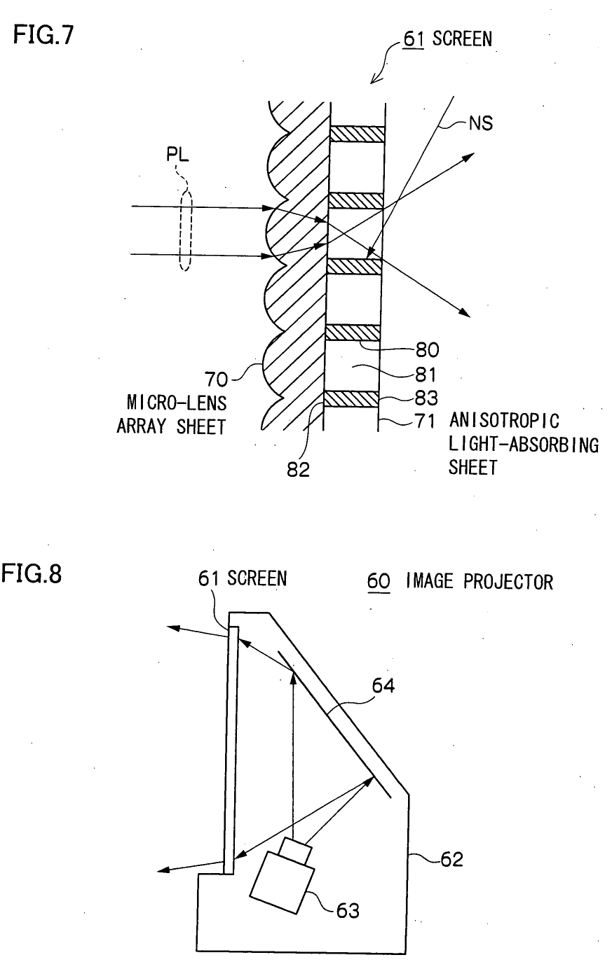

The screen 61 of the fourth embodiment comprises, as shown in an outline sectional view in FIG. 7, a micro-lens array sheet 70 arranged on the incident side of the optical image and an anisotropic light-absorbing sheet 71 of the fourth embodiment.

The micro-lens array sheet 70 has, as is known, a large number of micro lenses arranged laterally and longitudinally, for example, and an incident optical image is focused on each micro region by each micro lens. Each micro lens may have a curved face on both faces, but FIG. 7 shows an example of a flat face on one face.

The anisotropic light-absorbing sheet 71 is provided in contact with the flat-face side of the micro-lens array sheet 70. A method for bonding the micro-lens array sheet 70 and the anisotropic light-absorbing sheet 71 is not limited. For example, they may be bonded by pressing the peripheries of the both sheets with a frame member or by adhesion or fusion and the like.

Since the anisotropic light-absorbing sheet 71 is, as will be described later, a sheet-like optical component having anisotropy with different light-absorbing properties depending on incident direction, it is named “anisotropic light-absorbing sheet”. This anisotropic light-absorbing sheet has through cavities surrounded by light-absorbing side walls formed in a state closely collected in a large number, mutually sharing the side walls, and regardless of the incident face of external light, the sheet has the above anisotropy to all the incident lights with incident faces. The anisotropic light-absorbing sheet 71 transmits a component in an incident direction of a predetermined range while absorbing a component in the other incident direction of an optical image incident from the micro-lens array sheet 70. As a viewing angle of the screen 61, an angle depending on a position of an allowed observer is realized and an indoor light source or the external light from the outside through a window is absorbed and removed.

In general, for the anisotropic light-absorbing sheet 71 with the indoor light source being a fluorescent light or incandescent light, while the light ray entering into a room through the window being solar light, an absorbing characteristic to visible light is provided.

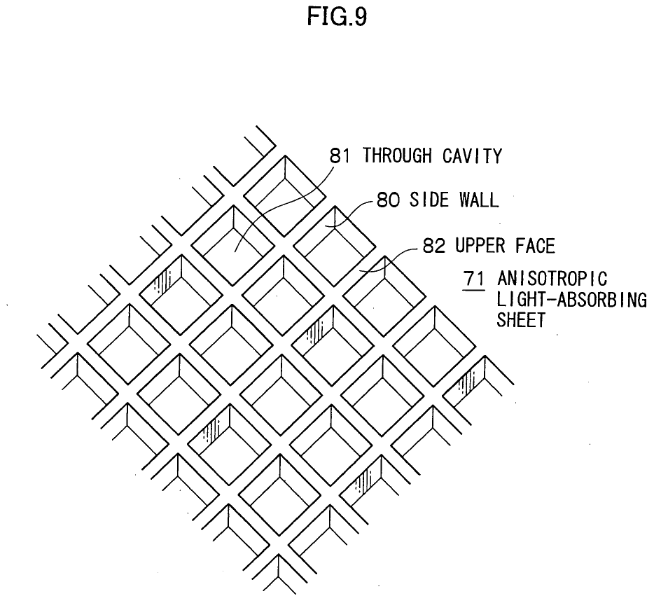

FIG. 9 is an outline perspective view relating to the anisotropic light-absorbing sheet of the fourth embodiment. The anisotropic light-absorbing sheet 71 of the fourth embodiment is web-like in which through cavities 81 are surrounded by light-absorbing side walls 80 collected closely in a large number, mutually sharing the side walls 80. The through cavity 81 is a complete cavity, in other words, only air is present therein.

The light-absorbing side wall 80 may be formed entirely by a single light-absorbing material or may be formed by the light-absorbing material only on the face of the side wall 80. It is preferable that a face on the incident side (upper face) 82 of the optical image and a face on the outgoing side (lower face) 83 of the optical image also have light absorbing properties.

As a light-absorbing material applied to the side wall 80, metal can be applied, glass containing light-absorbing pigment can be applied, polymer material containing the light-absorbing pigment or light-absorbing dye can be applied, and a conductive ceramic can be applied, for example.

By applying polymer material having flexibility such as vinyl chloride as the polymer material, the anisotropic light-absorbing sheet 71 and hence, the screen 61 can be made flexible.

Alternatively, if the conductive ceramic is applied as the light-absorbing material of the side wall 80, adhesion of dusts on the screen face by static charging can be prevented. Similarly, charging may be avoided by using an uncharged material other than the conductive ceramic or by non-charging processing.

If metal is used for the side wall 80, a light-absorbing layer may be provided on the face of the metal so as to form the light-absorbing side wall 80. Such a light-absorbing layer may be formed by applying a light-absorbing paint or by covering with the light-absorbing pigment or light-absorbing dye. If aluminum is applied as metal, the light-absorbing layer may be provided by black anodized aluminum processing. If chromium is applied as metal, the light-absorbing layer may be provided by face treatment causing change in the compound.

In the case of an example shown in FIGS. 7 and 9, each through cavity 81 has the same shape and is aligned with regularity. Here, the through cavity 81 is shown with a square profile. As shown in FIG. 7, the screen 61 in the fourth embodiment has the optical axis of each micro lens in the micro-lens array sheet 70 matched with the optical axis of each through cavity 81 of the anisotropic light-absorbing sheet 71.

If the anisotropic light-absorbing sheet 71 is formed by regularly aligning the through cavities 81 with the same profile, matching with the optical axis of each micro lens of the micro-lens array sheet 70 is easy and manufacture of the anisotropic light-absorbing sheet 71 is also easy.

However, the anisotropic light-absorbing sheet of the present invention is not limited to the anisotropic light-absorbing sheet 71 shown in FIGS. 7 and 9, but a large number of through cavities 81 may be aligned irregularly. Also, the profile of the through cavity 81 is not limited to a square and the size (area) of the profile of each through cavity 81 does not have to be the same.

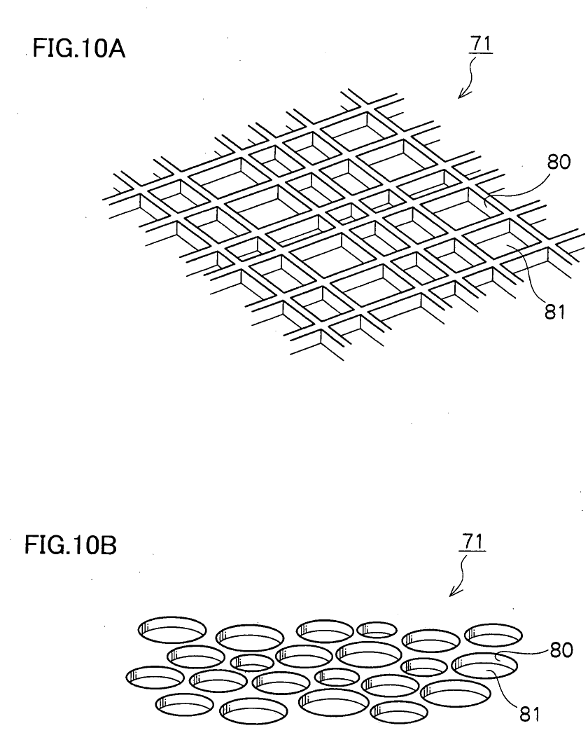

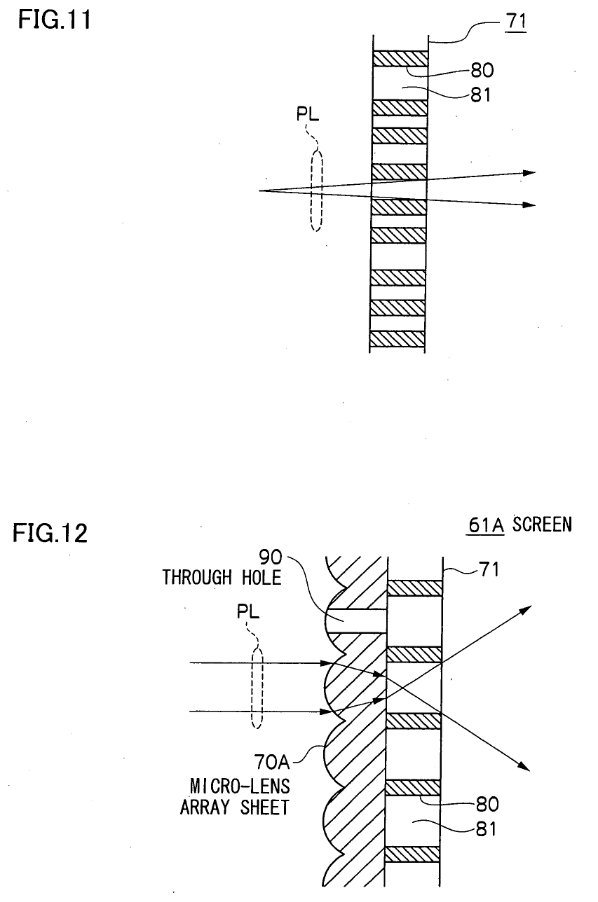

FIG. 10A shows the anisotropic light-absorbing sheet 71 in which the rectangular through cavities 81 with different profile sizes are arranged irregularly. FIG. 10B shows the anisotropic light-absorbing sheet 71 in which circular through cavities 81 with different profile sizes are arranged irregularly. Alternatively, a right triangle or a hexagon may be applied as the profile, for example. FIG. 11 is an outline sectional view of the anisotropic light-absorbing sheet 71 in which the through cavities 81 are arranged irregularly. Here, even if the through cavities 81 are arranged irregularly, each micro lens of the micro-lens array sheet 70 is preferably made to correspond to each through cavity 81 one by one so that the optical axes match.

Here, the anisotropic light-absorbing sheet with the through cavities arranged irregularly has such a merit that the moire phenomenon can be restrained, though manufacture or the like is more difficult than that of the anisotropic light-absorbing sheet with regular arrangement.

It is needless to say that plural types (two or three types, for example) of through cavities 81 with different profiles may be arranged regularly.

The optical image emitted from the projector body 63 and reflected by the mirror 64 is directed toward the screen 61. On the incident side in the screen 61, the micro-lens array sheet 70 is provided. Since a region on which each micro lens is formed is a micro region, the optical image in the near field of the micro lens can be considered to be approximately parallel light.

The parallel light PL incident to each micro lens is, as shown in FIG. 7, focused toward a predetermined point (focal point) in the corresponding through cavity 81 of the anisotropic light-absorbing sheet 71 by each micro lens, for example (the focal point may be at another position), and after having passed through the predetermined point (focal point), the light becomes diverging light inside the through cavity 81. Among the diverting lights, those having passed through the through cavity 81 without colliding with (incident to) the side wall 80 defining the through cavity 81 become the optical image provided for observation by an observer. Most of those colliding with (incident to) the side wall 80 defining the through cavity 81 among the diverting lights is absorbed by the side wall 80. As mentioned above, a desired viewing angle as the screen 61 is achieved.

Suppose that light ray emitted from an indoor light source such as a fluorescent light or incandescent light on a ceiling reaches the screen 61 as external light (disturbance light) NS as shown in FIG. 7. In the case of the fourth embodiment, the anisotropic light-absorbing sheet 71 is provided on the face side of the screen 61 exposed to the outside.

The external light NS incident with an angle to the anisotropic light-absorbing sheet 71 enters into the through cavity 81 and is absorbed by the side wall 80 having light absorbing properties and defining the through cavity 81 and removed. Even if several percents of the external light NS is reflected, the light is absorbed when it reaches the opposed side wall 80 and the more reflection is multiplied, the more completely the light is absorbed. Even if the incident angle is small, by selecting a longer length in the axial direction of the through cavity 81 (in other words, a thickness of the anisotropic light-absorbing sheet 71), the light reaches some spots of the side wall 80 and the external light NS is absorbed. Even if the light reaches the flat face of the micro-lens array sheet 70 and is reflected on the flat face, when the light reaches some spots of the side wall 80 in a path after the reflection, the light is absorbed there.

As mentioned above, the profile of the through cavity 81 may be of any type, but an average diameter value of an inscribed circle or a circumscribed circle of the profile is preferably approximately 50 to 200 μm and a length in the axial direction of the through cavity 81 (thickness of the anisotropic light-absorbing sheet 71) is approximately 50 to 200 μm. A specific value may be selected from these ranges considering a viewing angle required for the screen 61 and absorbing characteristic of the external light.

According to the anisotropic light-absorbing sheet of the fourth embodiment, since the through cavity surrounded by the light-absorbing side walls is in the web-like configuration, mutually sharing the side walls and collected closely in a large number, manufacture is easy and low costs can be expected.

According to the screen of the fourth embodiment, since the screen is constituted by the micro-lens array sheet and the anisotropic light-absorbing sheet, the manufacture is easy and low costs can be expected, and since the external light is absorbed and removed, the optical image with high image quality can be provided to the observer.

### (F) Fifth Embodiment of Screen for Image Projector

Next, a fifth embodiment of a screen for image projector according to the present invention will be described referring to the attached drawings. The screen of the fifth embodiment can be applied both to a rear screen used in a rear-projection image projector and to a front screen used in a front-screen image projector. Here, a case applied to the rear screen will be described. The image projector to which the screen of the fifth embodiment is applied has a sound source within the device enclosure, for example.

FIG. 12 is an outline sectional view illustrating a screen 61A of the fifth embodiment. The screen 61A of the fifth embodiment also comprises a micro-lens array sheet 70A arranged on the incident side and the anisotropic light-absorbing sheet 71.

A difference between the screen 61A of the fifth embodiment and that of the fourth embodiment is that a through hole 90 along the optical axis is provided at some micro lenses of the micro-lens array sheet 70A, while the anisotropic light-absorbing sheet 71 is the same as that of the fourth embodiment.

The through hole 90 communicates with the through cavity 81 of the anisotropic light-absorbing sheet 71 corresponding to the micro lens.

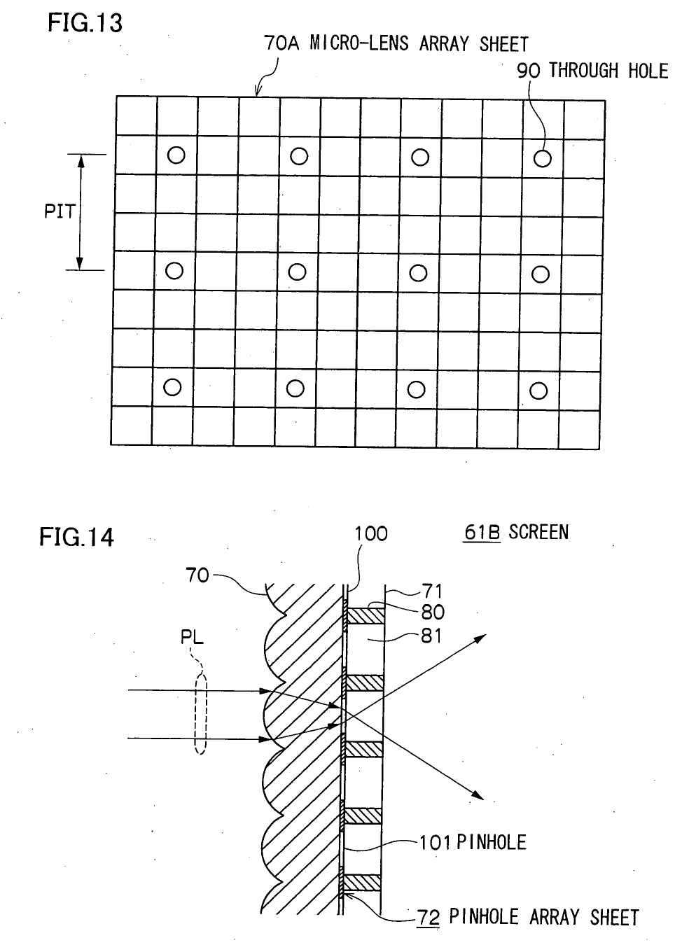

Arrangement of such plurality of through holes 90 is arbitrary. For example, as shown in FIG. 13, the through hole may be provided at each of the micro lenses separated with a predetermined distance PIT (5 cm, for example) laterally and longitudinally.

Such separation distance is preferably a distance so that the presence of the through hole 90 can not be recognized by an observer from the optical image through the screen 61A.

According to the screen of the fifth embodiment, the image display characteristics exert the same effect as that of the screen of the fourth embodiment. Moreover, according to the screen of the fifth embodiment, acoustics emitted from the sound source inside the enclosure of the image projector is led out to the outside through the communicating through hole 90 and the through cavity 81 and can be appropriately heard by the observer. Also, even if the temperature in the enclosure of the image projector is rising high due to the projection operation, since the inside and outside of the enclosure communicate with each other through the through hole 90 and the through cavity 81, the inside can be cooled.

### (G) Sixth Embodiment of Screen for Image Projector

Next, a sixth embodiment of a screen for image projector according to the present invention will be described referring to the attached drawings.

The screen of the sixth embodiment is a rear screen applied to a rear-projection image projector (See FIG. 8) similarly to the screen 61 of the fourth embodiment.

FIG. 14 is an outline sectional view illustrating a screen 61B of the sixth embodiment. The screen 61B of the sixth embodiment also comprises the micro-lens array sheet 70 arranged on the incident side, the anisotropic light-absorbing sheet 71, and a pinhole array sheet 72 arranged between them.

The micro-lens array sheet 70 and the anisotropic light-absorbing sheet 71 are similar to those of the fourth embodiment.

The pinhole array sheet 72 has a pinhole 101 provided on a light-absorbing pinhole array sheet body 100. The pinhole array sheet 72 is formed as a single component and it may be bonded between the micro-lens array sheet 70 and the anisotropic light-absorbing sheet 71, may be formed integrally on the output face of the micro-lens array sheet 70, and moreover, may be formed integrally on the incident face of the anisotropic light-absorbing sheet 71. The pinhole 101 can be formed by applying the photo-etching method, for example.

Each pinhole 101 corresponds to the micro lens on the incident side and the through cavity 81 on the outgoing side, and their optical axis match each other. Each pinhole 101 is provided at a focal position of the corresponding micro lens or its near field. In FIG. 14, a case where the through cavities 81 with the same shape are arranged regularly is shown, but even if the through cavities 81 with various sizes are arranged irregularly, each pinhole 101 is provided with the optical axis matched with the incident side of the corresponding through cavity 81.

The pinhole 101 may be formed by a cavity (air layer) or may be a micro optical window in which a transparent material is present. Alternatively, the pinhole 101 may be applied treatment to give diffusivity to transmitted light. The anisotropic light-absorbing sheet 71 may be a cylindrical optical opening or may be an optical opening in a conical trapezoidal shape.

In the sixth embodiment, since the pinhole 101 is formed in the near field of the focal point of the corresponding micro lens, the light of optical image focused by the micro lens is transmitted without being disturbed by the pinhole 101. The light having passed through the pinhole 101 becomes the optical image to be provided for observation by an observer similarly to the fourth embodiment.

Since one face of the micro-lens array sheet 70 becomes invisible to the observer side by the presence of the pinhole array sheet body 100, in other words, since the optical image is observed by the observer from a black base, an optical image with high contrast can be provided to the observer.

The external light is also absorbed and removed by the anisotropic light-absorbing sheet 71 basically, similarly to the fourth embodiment. Even if the light should reach the pinhole array sheet 72, it is absorbed and removed by the light-absorbing pinhole array sheet body 100, which is a portion other than the pinhole 101 of the pinhole array sheet 72. In other words, it can be regarded that there is substantially no external light entering into the device enclosure through the pinhole 101, and the external light can be prevented from entering into the device enclosure to become stray light and giving infection.

As mentioned above, according to the sixth embodiment, in addition to an effect similar to that of the fourth embodiment, an effect of improvement in image quality by provision of the pinhole array sheet can be expected.

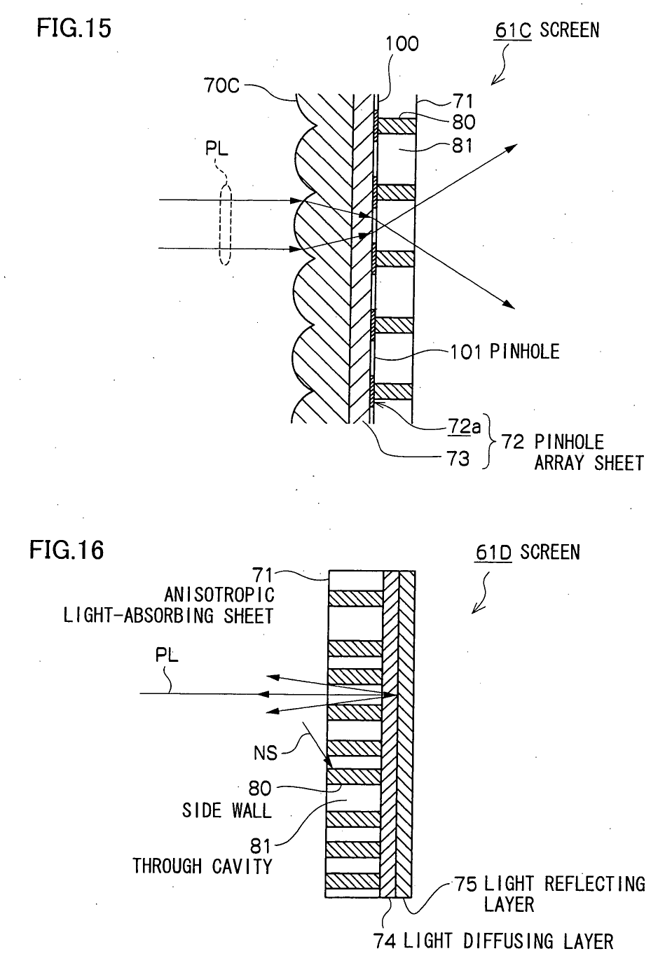

FIG. 15 shows a variation embodiment relating to the screen of the sixth embodiment. A screen 61C shown in FIG. 15 has a micro-lens array sheet 70C, a transparent flat plate 73, the pinhole array sheet 72, and the anisotropic light-absorbing sheet 71.

In this variation embodiment, the pinhole array sheet 72 comprises the transparent flat plate 73 and a pinhole array layer 72a. It is difficult to manufacture the pinhole array sheet 72 and a part of the anisotropic light-absorbing sheet 71 as a single member, but it is easy to form the pinhole array layer 72a on the transparent flat plate 73. Here, the pinhole array layer 72a is a layer in which a pinhole array is formed by working a light-absorbing layer formed on the transparent flat plate 73 by photolithography and the like. As a sheet-like optical component having light absorbing property, handling and sales become easy.

It is needless to say that a technical idea of providing through holes in some micro lenses as in the fifth embodiment and a technical idea of providing a pinhole array sheet as in the sixth embodiment may be combined.

### (H) Seventh Embodiment of Screen for Image Projector

Next, a seventh embodiment of a screen for image projector according to the present invention will be described referring to the attached drawings.

The screen of the seventh embodiment is a so-called front screen applied to a front-projection image projector. A positional relation between a projector body projecting an optical image and the front screen is similar to the positional relation between the projector body 63 and the mirror 64 in FIG. 8.

FIG. 16 is an outline sectional view illustrating a screen 61D of the seventh embodiment. The screen 61D of the seventh embodiment has the anisotropic light-absorbing sheet 71, a light diffusing layer 74, and a light-reflecting layer 75 from the incident and output face side.

The anisotropic light-absorbing sheet 71 is similar to that of the fourth embodiment. However, since the optical image from the projector body reciprocally travels in the through cavity 81, a length in the axial direction of the through cavity 81, in other words, a thickness of the anisotropic light-absorbing sheet 71 is thinner than the case of a rear screen in each of the above embodiments, for example. FIG. 16 shows the anisotropic light-absorbing sheet 71 in which the through cavities 81 with various sizes are arranged irregularly, but it is needless to say that the anisotropic light-absorbing sheet 71 in which the through cavities 81 with the same shape are arranged regularly may be applied to the screen 61D of the seventh embodiment.

The light diffusing layer 74 diffuses incident light when it is transmitted through the light diffusing layer 74, and the light-reflecting layer 75 reflects the incident light. The light diffusing layer 74 and the light-reflecting layer 75 are similar to those of an existing front screen. As the light-reflecting layer 75, those formed by depositing aluminum, silver and the like on a PET substance and the like may be applied.

As the light diffusing layer 74, those in which a large number of transparent beads made by acryl or styrene are affixed may be applied, for example. Also, as the light-reflecting layer 75, those obtained by binding a scattering oxide (MgSO₄, MgO, BaSO₄ and the like) powder by polymer material can be applied, for example.

Here, the optical axis of the through cavity 81 of the anisotropic light-absorbing sheet 71 is preferably parallel with a normal direction of the light-reflecting layer 75, but not limited to that.

The optical image emitted from the projector body, not shown, enters the screen 61D of the seventh embodiment directly or by being reflected by a mirror and the like, not shown. The optical image incident as above can be regarded as parallel light along the optical axis of the through cavity 81 when seen from each through cavity 81 with a small sectional area of the anisotropic light-absorbing sheet 71.

The parallel light PL traveling through each through cavity 81 along its optical axis is diffused when transmitted through the light diffusing layer 74 and reaches the light-reflecting layer 75. The light reflected by the light-reflecting layer 75 (diffused light) is diffused when transmitted through the light diffusing layer 74 again. Even by this diffusion, the light travels through the through cavity 81 without reaching the side wall 80 and the light emitted outside the through cavity 81 becomes the optical image to be provided for observation by the observer. Those in the diffused light colliding with (incident to) the side wall 80 defining the through cavity 81 are absorbed by the side wall 80. As mentioned above, a desired viewing angle as the screen 61D is achieved.

Suppose that light ray emitted by an indoor light source such as a fluorescent light or incandescent light on a ceiling reaches an observation face of the screen 61D as the external (disturbance light) NS as shown in FIG. 16. In the case of the seventh embodiment, the anisotropic light-absorbing sheet 71 is provided on the observation face side.

The external light NS incident with an angle to the anisotropic light-absorbing sheet 71 enters the through cavity 81 and is absorbed by the side wall 80 having light absorbing property and defining the through cavity 81 and removed. Even if several percents of the external light NS is reflected, the light is absorbed when it reaches the opposed side wall 80 and the more reflection is multiplied, the more completely the light is absorbed. Even if the incident angle of the external light NS is somewhat small, by selecting a longer length in the axial direction of the through cavity 81 (in other words, a thickness of the anisotropic light-absorbing sheet 71), the light reaches some spots of the side wall 80 and the external light NS is absorbed. Even if the light reaches portions of the light diffusing layer 74 and the light-reflecting layer 75, the diffusing direction by the light diffusing layer 74 has an angle as compared with the case of the optical image, and the light reaches some spots of the side wall 80 in a path after the reflection, the light is absorbed there.

According to the front screen of the seventh embodiment, too, since it is constituted using the anisotropic light-absorbing sheet of the fourth embodiment, manufacture is easy and low cost can be expected, and since the external light is absorbed and removed, the optical image with high image quality can be provided to the observer.

### (I) Embodiment of Manufacturing Method of Anisotropic Light-Absorbing Sheet

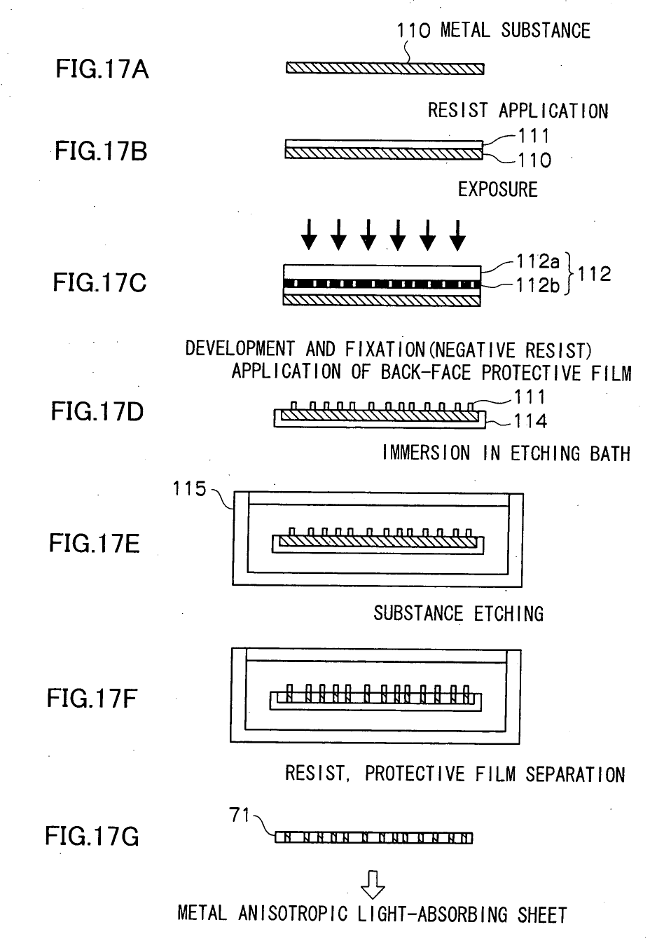

Next, an embodiment of a manufacturing method of the anisotropic light-absorbing sheet (71) appropriately applied to a screen for image projector as mentioned above will be described referring to FIG. 17. This embodiment is a manufacturing method of a metal anisotropic light-absorbing sheet.

Resist 111 is applied on one face of a metal substance 110 (its thickness is 50 to 200 μm as mentioned above) to be the metal anisotropic light-absorbing sheet (71) after working (See FIG. 17B).

Then, a mask 112 including a mask substance 112a and a mask pattern face 112b is overlapped and exposed (See FIG. 17C).

Here, a type of the resist and the mask pattern are applied so that a portion to be the side wall 80 of the anisotropic light-absorbing sheet (71) remains by development and fixation (negative resist). After the development and fixation, on a back face (and a side face) of the metal substance 110, a protective film 114 from an etchant is provided by application (FIG. 17D).

After that, the metal substance 110 on which the negative resist 111 remains and the protective film 114 is applied is dipped in an etching bath 115 in which the etchant is contained so that a portion of the metal substance 110 on which the negative resist 111 does not remain is removed (See FIGS. 17E, 17F).

And finally, the metal substance 110 is taken out of the etching bath 115, and the negative resist 111 and the protective film 114 are removed (See FIG. 17G). As a result, the metal anisotropic light-absorbing sheet 71 is completed.

According to this embodiment, the metal anisotropic light-absorbing sheet can be formed easily by a known method like photo-etching method. Here, by the mask pattern, the anisotropic light-absorbing sheet with the through cavities 81 arranged regularly or the anisotropic light-absorbing sheet with the through cavities 81 arranged irregularly can be easily fabricated, and freedom in the profile and size of the through cavity 81 is high.

### (J) Embodiment of Manufacturing Method of Die for Anisotropic Light-Absorbing Sheet

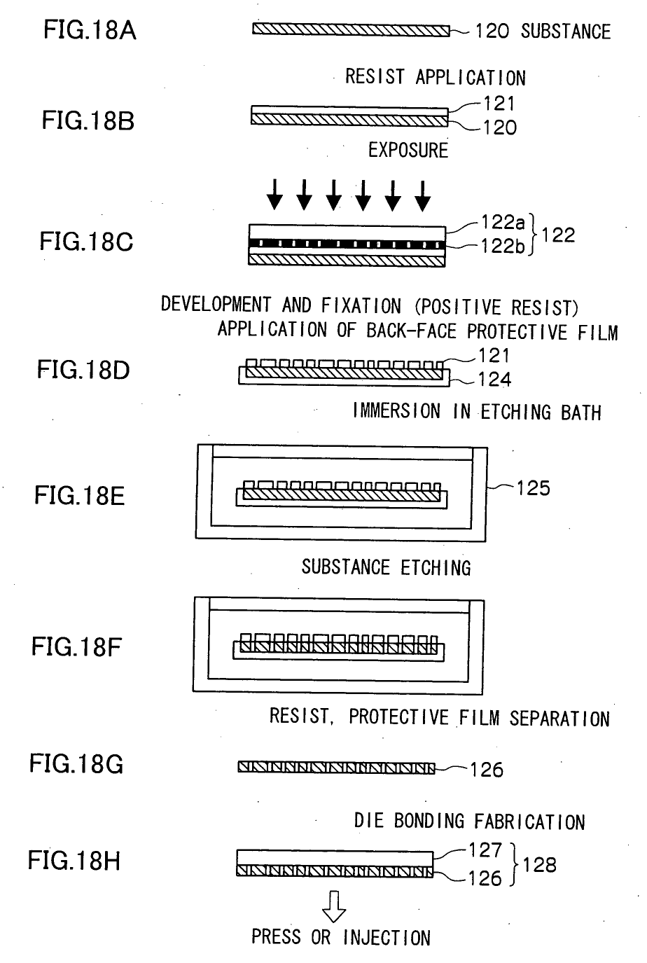

Next, an embodiment of a manufacturing method of a die used for manufacture of the anisotropic light-absorbing sheet (71) will be described referring to FIG. 18.

In the above, a case of manufacturing the anisotropic light-absorbing sheet (71) made of a single material by applying the photo-etching method was explained. But the manufacturing method of the anisotropic light-absorbing sheet (71) made of a single material is not limited to the above embodiment. The anisotropic light-absorbing sheet (71) may be manufactured by directly drilling the through cavity (81) in the substance by laser machining, for example. Alternatively, the anisotropic light-absorbing sheet may be manufactured by making a die and by carrying out injection using the die, for example. Moreover, the anisotropic light-absorbing sheet may be manufactured by making a die and by pressing the die on the substance and partially punching so as to provide the through cavity in the substance, for example.

The manufacturing method of a die for anisotropic light-absorbing sheet of this embodiment can be applied to manufacture of a die for manufacturing the anisotropic light-absorbing sheet by injection or to manufacture of a die for manufacturing the anisotropic light-absorbing sheet by press.

Resist 121 is applied on one face of a substance 120 (its thickness is 100 to 200 μm) to be a body of a die by which the anisotropic light-absorbing sheet (71) is fabricated after working (See FIG. 18B). Then, a mask 122 including a mask substance 122a and a mask pattern face 122b is overlapped and exposed (See FIG. 18C). Here, as the substance 120 to be the die body, those with high durability such as crystallized glass substance or metal substance are applied.

A type of the resist and the mask pattern are applied so that a portion to be the through cavity (81) of the anisotropic light-absorbing sheet (71) remains by development and fixation (positive resist). After the development and fixation, on a back face (and a side face) of the substance 120, a protective film 124 from an etchant is provided by application (FIG. 18D).

After that, the substance 120 on which the positive resist 121 remains and the protective film 124 is applied is dipped in an etching bath 125 in which the etchant is contained so that a portion of the substance 120 on which the positive resist 121 does not remain is removed (See FIGS. 18E, 18F).

And finally, the substance 120 is taken out of the etching bath 125 and the positive resist 121 and the protective film 124 are removed (See FIG. 18G). As a result, a die body 126 is completed. By mounting a bonding portion 127 used when mounting the die on an injection machine or press machine, not shown, on the die body 126, a die 128 is completed (See FIG. 18H).

The anisotropic light-absorbing sheet (71) is manufactured by injection or punching press using such die 128.

According to this embodiment, a die that can easily manufacture the anisotropic light-absorbing sheet (71) can be easily manufactured by a known method like photo-etching method. Here, by the mask pattern used at manufacture of the die, not only that a die that can easily fabricate the anisotropic light-absorbing sheet having the through cavities 81 arranged regularly or the anisotropic light-absorbing sheet with the through cavities 81 arranged irregularly can be easily manufactured, but a die that can easily fabricate the anisotropic light-absorbing sheet having freedom in the profile and size of the through cavity 81 can be manufactured.

### (K) Other Embodiments

In the fourth embodiment and after, manufacturing methods of the anisotropic light-absorbing sheet entirely made of a single material were illustrated, but any anisotropic light-absorbing sheet provided with the light-absorbing layer only on the face can be manufactured as follows, for example. An anisotropic light-absorbing sheet in a stage where the light-absorbing layer has not been provided is fabricated by applying the photo-etching method as shown in FIG. 17 on a crystallized glass substance, for example. After that, a nickel layer is provided only for 200 to 1000 Å by electroless plating of nickel (Ni) and then, a chromium layer functioning as the light-absorbing layer is provided only for several μm by chromium (Cr) plating. The anisotropic light-absorbing layer manufactured as above has crystallized glass as a core material of the sheet and has higher machining accuracy than the metal anisotropic light-absorbing sheet manufactured by the manufacturing method in FIG. 17.

In the above, a case where the anisotropic light-absorbing sheet of the present invention is applied to the screen for image projector was explained, but applications of the anisotropic light-absorbing sheet of the present invention are not limited to that.

For example, the anisotropic light-absorbing sheet of the present invention may be affixed to one face of a window pane of a building so as to shield external light. Here, as an absorption wavelength band, a wavelength band of ultraviolet or infrared may be selected instead of that of white so that only ultraviolet shielding function or infrared shielding function can be realized. Alternatively, in the case of adhesion on the window pane, by increasing the thickness of the anisotropic light-absorbing sheet (in other words, the length in the axial direction of the through cavity), a function to prevent peeping into a room can be performed.

Alternatively, a function to remove external light can be realized by affixing the anisotropic light-absorbing sheet of the present invention on a display face of a cellular phone, for example.

1. An optical sheet comprising:
a micro-lens array sheet with a flat face, and a back face having micro lenses aligned laterally and longitudinally; and
an anisotropic light-absorbing sheet with different light absorbing properties depending on an incident angle of incident light entering an incident face, the micro-lens array sheet and the anisotropic light-absorbing sheet being arranged oppositely and proximally to each other.

2. The optical sheet according to claim 1, wherein
said micro-lens array sheet, said anisotropic light-absorbing sheet, and moreover, a pinhole array sheet are arranged proximally in this order.

3. The optical sheet according to claim 2, wherein
said micro-lens array sheet, said anisotropic light-absorbing sheet, said pinhole array sheet, and moreover, a light diffusing sheet are arranged proximally in this order.

4. The optical sheet according to claim 1, wherein
said anisotropic light-absorbing sheet is provided with through cavities mutually sharing side walls, collected closely in a large member and surrounded by said light-absorbing side walls.

5. The optical sheet according to claim 4, wherein
the light-absorbing side wall is made of metal, glass containing light-absorbing pigment or polymer material containing light-absorbing pigment or dye.

6. The optical sheet according to claim 4, wherein
the light-absorbing side wall has a light-absorbing layer formed on the face.

7. The optical sheet according to claim 4, wherein
each of the through cavities has the same shape and a plurality of the through cavities are aligned with regularity.

8. The optical sheet according to claim 4, wherein
each of the through cavities has a profile on a cross section orthogonal to its optical axis direction not uniform and a plurality of the through cavities are arranged irregularly.

9. A screen for image projector applied to a front-projection image projector, comprising: an anisotropic light-absorbing sheet in which through cavities surrounded by light-absorbing side walls mutually share the side walls and are collected closely in a large number; a light diffusing layer; and a light-reflecting layer, the anisotropic light-absorbing sheet, the light diffusing layer, and the light-reflecting layer being provided in this order.

10. A screen for image projector applied to a rear-projection image projector, comprising the anisotropic light-absorbing sheet according to claim 4 and a micro-lens array sheet.

11. The screen for image projector according to claim 10, wherein optical axes of micro lenses constituting the micro-lens array sheet and the through cavities are the same.

12. The screen for image projector according to claim 11, wherein a part of the micro lenses has through holes communicating with both faces, and the through holes communicate with the through cavities relating to the same optical axis.

13. The screen for image projector according to claim 10, wherein a pinhole array sheet having a pinhole in the near field of a focal position of each micro lens is provided between the anisotropic light-absorbing sheet and the micro-lens array sheet.

14. An image display device using an image display element for image display by modulation of light intensity emitted from each pixel depending on an electric signal, the image display device using an optical sheet, comprising:
a micro-lens array sheet with a flat face, and a back face having micro lenses aligned laterally and longitudinally; and
an anisotropic light-absorbing sheet with different light absorbing properties depending on an incident angle of incident light entering an incident face, the optical sheet having the micro-lens array sheet and the anisotropic light-absorbing sheet arranged oppositely and proximally to each other so that the flat face of the micro-lens array sheet in the optical sheet is faced with a display face of the image display element.

15. The image display device according to claim 14, wherein
the optical sheet has a transparent adhesive formed on the face on the micro-lens array sheet side, capable of being bonded to another optical component.
